(19) United States
(12) Patent Application Publication
(10) Pub. No.: US 2004/0134620 A1
(43) Pub. Date: Jul. 15, 2004

(54) Printer for preparing at least labels as destination information carriers for an article to be transported and a tag, a system and a method thereof

(76) Inventor: Jens La Cour Soeborg, Randers (DK)

Correspondence Address: CHRISTIE, PARKER & HALE, LLP, 350 WEST COLORADO BOULEVARD, SUITE 500, PASADENA, CA, 91105, US

(21) Appl. No.: 10/399,897

(22) PCT Filed: Oct. 23, 2001
(86) PCT No.: PCT/EP01/12250

(30) Foreign Application Priority Data
Oct. 23, 2000 (DE) 100 52 444.3

(51) Int. Cl. B32B 31/00; B41M 1/00

(52) U.S. Cl. 156/384; 156/277

(57) ABSTRACT

The invention relates to the use of an RFID label (40) as a destination information carrier for an article (K) to be transported, in particular a piece of baggage, a printer (10) for preparing at least labels (50) as destination information carriers for the article (K) to be transported, a tag (60) for an article (K) to be transported and a system for labeling an article (K) to be transported and a method therefor. According to the invention it is provided that an RFID label (50) remains on a piece of baggage (K) to be transported until said label (40) has a malfunction and has to be replaced.

The present invention concerns the use of an RFID label for labeling an article to be transported, in particular a piece of baggage, a printer, a tag, a system and a method therefor as set forth in claims 1, 3, 10, 23 and 28.

The automated dispatch of articles, in particular pieces of baggage, involves the problem of providing them with information about the respective destination. Pieces of baggage which are carried along for example by airline passengers and which cannot be stowed within the cabin of an aircraft are handed in at the check-in. In that case each individual piece of baggage then has to be provided with information regarding the destination of the airline passenger and thus the piece of baggage. For that purpose after the ticket has been given in a label in the form of an elongate strip is printed by means of a suitable printer, the destination information being printed both in uncoded form in plain text by means of abbreviations and also encoded in the form of a bar code. That label is then fixed to the piece of baggage, generally by being passed through the handle and glued together at its two free ends at which it is provided with a layer of adhesive. The piece of baggage is then transported to the respective aircraft by means of a suitable conveyor device. As the conveyor system has a plurality of switching points and branching locations, the piece of baggage must be identified at the switching points, in particular in regard to its destination, so that the switching points can assume an appropriate position. For that purpose, bar code scanners must be provided in the conveyor system at various locations, which scanners can detect the bar code produced by means of the printer. In that case however the problem frequently arises that the bar code cannot be properly detected because the label has been inappropriately attached to the piece of baggage and/or because of fouling of the label or the scanner. The result of this is that the piece of baggage is mis-routed, whereby the piece of baggage has to be returned to the owner, which involves a high level of cost.

The object of the present invention is to eliminate the above-mentioned disadvantages and in particular to provide a printer for preparing at least labels as destination information carriers for an article to be transported, a tag therefor, a system therefor and a method therefor, which permit reliable identification of the destination.

The foregoing object is firstly attained in that, instead of a label provided with a bar code and the like, an RFID label is used. Such an RFID label makes it possible to write to the label and read out the items of information thereof, by means of preferably radio waves. A writing and reading operation of that kind is independent of the position of the label in relation to the respective reading and/or writing unit and in addition is also independent of other influences such as fouling of the label and so forth. In that way it is possible to provide for reliable and secure control of the article to be transported to its destination, particularly in the case of conveyor systems having switching points which are to be set on the basis of the label and the information contained therein.

As moreover an RFID label can be read and written to a plurality of times, there is also the possibility of leaving the RFID label on the article to be transported after it has reached its destination. Then, for the next transportation phase, that RFID label which is already on the article can be used for input of the items of destination information. It is only when the RFID label has a defect that it has to be replaced by a new RFID label.

It is to be noted in this connection that the terms destination information or items of destination information for an article to be transported is used to denote both a complete data set of such items of destination information and also parts thereof. If the items of destination information are too extensive for them to be written for example on to a single RFID label, it can also be provided that disposed on the article to be transported are two or more RFID labels which each partially contain the items of destination information. It can further be provided that, besides the pure items of destination information for the article to be transported, further items of information can be written into or read from the RFID label.

So that, besides electromagnetic storage of the destination information or items of destination information, a user or another person also has the possible option of reading such items of destination information or at least parts thereof in plain text, it can further be provided that the RFID label is printed upon with such information in uncoded form.

The foregoing aspect can also be attained in that, besides the RFID label, a further ‘classic’ label with corresponding information both in coded and also uncoded form can be fixed to the article to be transported.

In terms of the printer the foregoing object is attained by the features of claim 3. Advantageous configurations in that respect are set forth in subsequent claims 3 through 9.

The provision of a printer which is in a position both to write to an RFID label and also to print a ‘normal label’ which contains at least a part of the destination information in encoded form, for example in the form of a bar code, and/or in uncoded form, affords the possibility of providing both an RFID label and also a normal label with the destination information, with a single apparatus.

If the article to be transported already has an RFID label which has been used in the last transport operation, it is advantageous if there is provided a writing/reading unit for an RFID label, preferably independently of the printer. In that way it is possible to check whether the RFID label is fault-free or whether it possibly has to be replaced. In the case of replacement or fresh preparation of an RFID label it is further advantageous if the printer is provided with a reading unit for RFID labels in order to check the freedom from fault of the new or unwritten RFID label. For that purpose it has proven to be advantageous if the reading unit for an RFID label is arranged upstream of the printing unit of the printer, in the feed direction. It is also to be noted in this connection that the reading unit for an RFID label and the writing unit for an RFID label can either be provided separately in the printer or however combined together in a common unit.

Besides a feed device for the RFID label and a further feed device for the label which is to be printed upon by means of the printing unit, it is possible to provide further feed devices so that, besides the two labels, the printer can also produce further documents, for example documents which are used independently of the article to be transported.

Each of the feed devices can be connected to a supply unit for a respective kind of a print element to be printed upon or RFID label to be written to. That affords the possibility, in the case of a defective RFID label, of dispensing a new RFID label. The supply units in that case can be so designed that both print materials in roll form and also in individual sheet form or in the form of blocks which are folded in concertina-like manner or in the form of fanfold blocks can be arranged in the printer.

Besides the reading unit for RFID labels it is also possible to provide a reading unit for smart cards on the printer in order thereby to prepare other forms of information transfer. If for example the printer according to the invention is used again in relation to air journeys it is then possible instead of a ticket also to use a smart card, whose flight information already stored thereon are then read by the printer and written for writing for the RFID label, whether it is already on the article to be transported or whether it is still in the printer in the form of an unwritten RFID label, thus providing for automatic information transfer from the smart card to the RFID label. It will be appreciated that the information contained in the smart card can also be transferred to the first and each further label or each further document to be prepared by the printer. It is to be noted in this connection that, instead of a reading unit for smart cards, it is also possible to provide a reading unit for other items of information stored in magnetised form, for example for travel documents provided with a magnetic strip which contains the items of travel information.

It should also be observed in this connection that obviously besides a reading unit for smart cards it is also possible to provide a writing unit for smart cards in the printer.

In regard to the tag the foregoing object is attained by the features of claim 10. Advantageous configurations in that respect are set forth in subsequent claims 11 through 22.

The provision of a tag on the article to be transported affords the possibility of receiving the RFID label in protected form, for example in a first receiving device of the tag, and leaving it on the article to be transported after a first transport operation in which the RFID label has been attached to the article to be transported prior to or during the transport operation. In addition the tag makes it possible to receive for example a further label which contains at least a part of the destination information in encoded and/or uncoded form. That label is received in a second receiving device.

As the information contained in an RFID label is transferred from and to the RFID label by means of radio waves, there is no need for the RFID label to be provided at the outside of the tag. It is therefore advantageous if the label to be printed upon by the printer is arranged over the RFID label. Then for example a wall of the tag casing can be provided beneath the RFID label.

So that the label printed upon with encoded or uncoded information in regard to destination is visible from the outside, it is advantageous if the tag is provided with a reading window for that label.

Besides the first label to be printed by the printer, it is possible to provide a second label which for example contains personal data in the form for instance of a business card but also advertising information and which is produced in each writing operation to the RFID label or in each printing operation for the first label or remains unchanged over a prolonged period of time. For that purpose a third receiving device for receiving that second label is provided in the tag. As already indicated hereinbefore that second label can remain in the tag for a prolonged period of time or can be produced afresh when writing to the RFID label and introduced into the third receiving device.

The third receiving device may also have a reading window which is accessible from the exterior.

In order to protect the RFID label from damage or other adverse effects it can further be provided that the first receiving device for the RFID label is arranged between the second and the third receiving devices for the first and second labels to be printed.

The receiving devices can be of quite different configurations. Thus for example it is possible for the receiving devices to be formed by two guide grooves or guide bars which are disposed in mutually opposite relationship and which embrace the flat labels in a C-shape. That means that the labels can be pulled out of or pushed into the tag in a simple manner. In order to prevent unintentional removal of the label or labels from the tag, it is further possible to provide a releasable locking device, for example a hook-and-loop fastener, a snap-action fastener and so forth.

So that the tag can be fitted to any article to be transported, it is further advantageous if the fixing means is releasable.

So that the information contained in the RFID label is not destroyed by abrupt electrostatic discharges, it is further advantageous if the RFID label is electrostatically insulated with respect to the casing.

In addition it is advantageous if the casing is produced from an electrically non-conductive material, preferably plastic material.

In order to prevent bending and folding of the RFID label it is further advantageous if the casing is stiff.

The system for identifying an article to be transported is attained by the features of claim 23. Advantageous configurations are set forth in subsequent claims 24 through 27.

The foregoing system essentially includes a printer as set forth in one of claims 2 through 9, at least one tag as set forth in claims 10 through 22 and at least one RFID label. In that system, the advantages already discussed hereinbefore occur in terms of the printer, the tag and the RFID label. It remains to be noted once again that the RFID label affords the possibility of providing an article to be transported such as for example a piece of baggage with one and the same RFID label over a prolonged period of time, that is to say over a plurality of transport operations, which RFID label can be freshly written to with the corresponding destination information or parts thereof, for each transport operation.

Besides the RFID reading unit which can already be provided in the printer, it is also possible for the system to include an RFID reading unit which is independent thereof. That RFID reading unit which is independent of the printer serves to check freedom from fault of an RFID label before it is written to, with new destination information. Besides that RFID reading unit which is independent of the printer, it is possible within the system to provide a plurality of persons with portable RFID reading units which are in a position to read out the information on the RFID label and to represent it in plain text, that is to say in uncoded form, for the user. That affords the possibility, in the event of a fault or other impairment, for the information contained in the RFID label to be read out and for the piece of baggage to be possibly manually transported to the intended destination.

It has further proven to be advantageous if the system includes an input/output unit for a computer, by means of which unit the destination information can be prepared on the basis of input information and transferred into a suitable coding form for the RFID label. In that respect it is further found to be advantageous if the input/output unit is provided with a reading unit for data stored in magnetic form. In that way, for example in regard to air journeys, there is the possibility of automatically reading in the flight ticket which contains all relevant information in terms of destination, flight number and so forth, processing those items of information in the computer and then providing the associated RFID label of the piece of baggage with the respective information.

The foregoing method is attained by the features of claim 28. Advantageous configurations in that respect are set forth in subsequent claims 29 through 33.

In principle it is to be noted that the method makes it possible to achieve the same advantages as have been attained hereinbefore in connection with the use of an RFID label, the printer, the tag and the system.

Further advantageous configurations and an embodiment of the invention are described hereinafter with reference to the drawings. In this connection it is to be pointed out that the terms used ‘left’, ‘right’, ‘down’ and ‘up’ relate to the Figures of the drawings with the Figure labeling in the normally readable position. In the drawing:

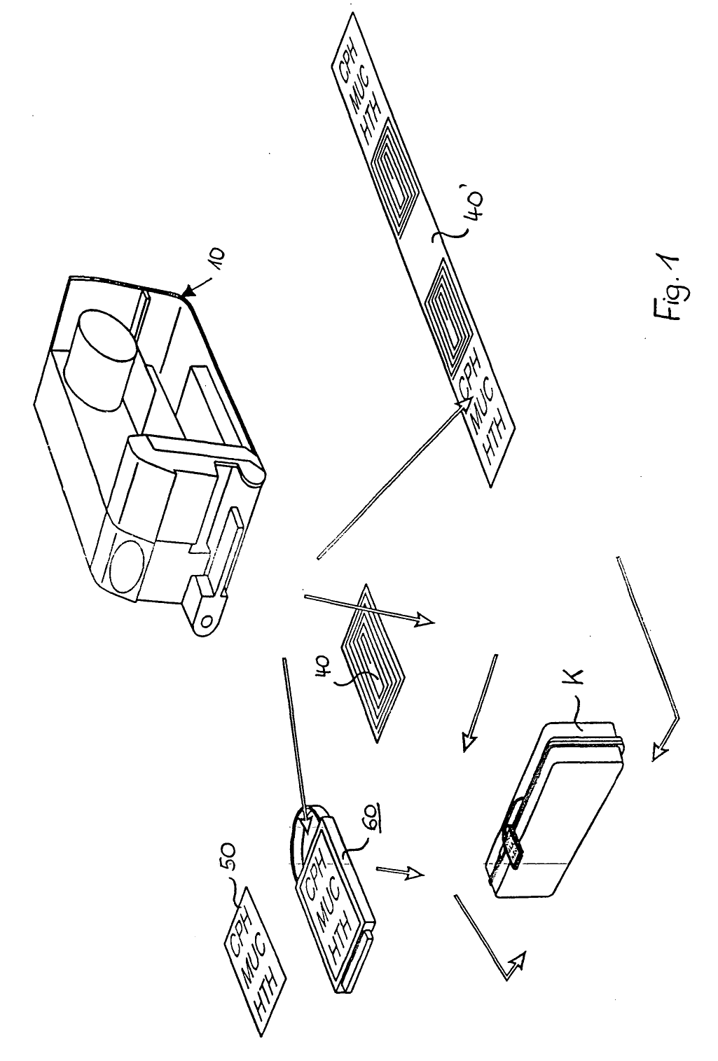

FIG. 1 is a diagrammatic overview of the individual components of a system according to the invention,

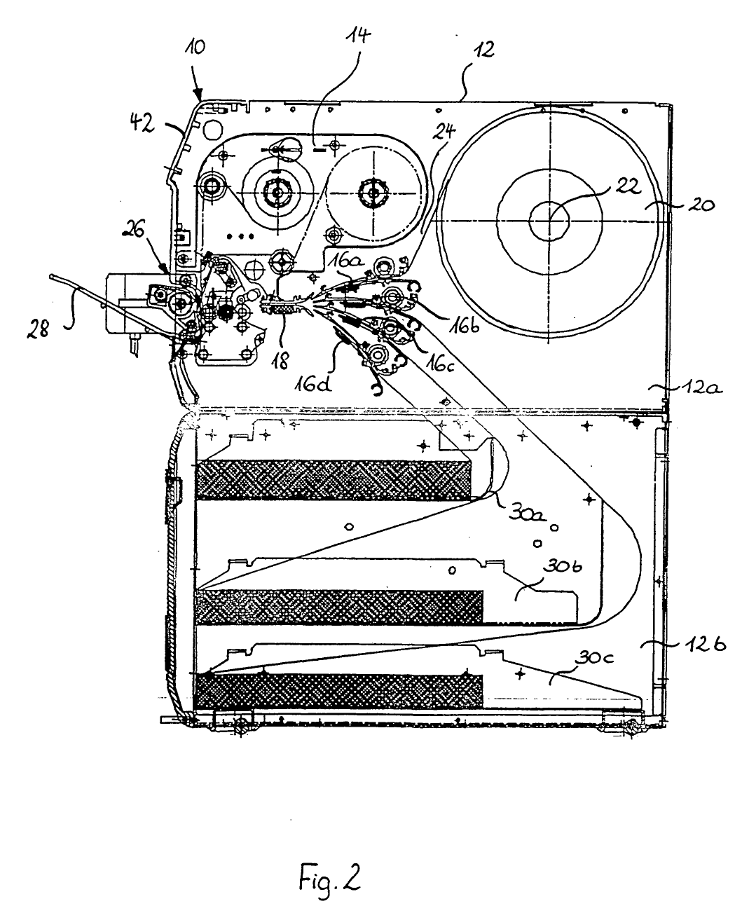

FIG. 2 is a diagrammatic view in cross-section of a printer according to the invention, and

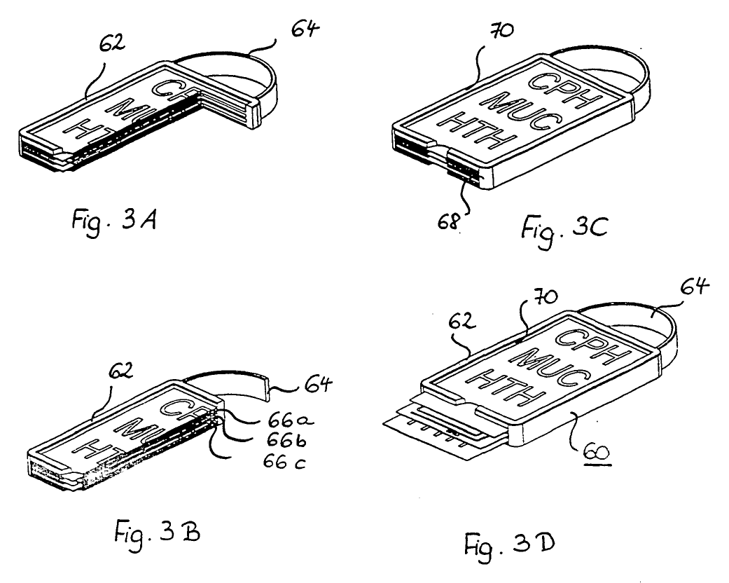

FIGS. 3A-3D are perspective, partly sectional views of a tag according to the invention.

FIG. 1 shows essential components of the system according to the invention. A printer 10 which is only diagrammatically shown in FIG. 1 and which is described in greater detail hereinafter with reference to FIG. 2 is in a position to deliver both an RFID label 40 and also a label 50 to be printed, with the respective destination information in uncoded and/or encoded form. In addition the printer 10 can also prepare a combination of an RFID label and a label to be printed having destination information in uncoded and/or encoded form, as is shown at the right in FIG. 1 with the strip-shaped RFID label 40′. In this case the two ends of the strip 40′ can be provided on the side which is not shown with a coating of adhesive by means of which those ends are glued together after the strip 40′ has been passed through an eye and the like on the article to be transported, so that the strip-shaped 40′ is attached to the article. The adhesive coatings can be protected by means of suitable films which are pulled off same when the ends are glued together.

The RFID label 40 and the label which is to be printed or which has been printed, with destination information in encoded and/or uncoded form, can be received by a tag 60 which is attached to an article to be transported, in this case a piece of baggage in the form of a case K, for example to the handle of the respective piece of baggage K. If the piece of baggage K is already provided with a tag 60 which receives at least an RFID label 40, the printer 10 does not have to dispense a new RFID label 40 but only has to be provided by means of a suitable writing/reading unit for RFID labels, which is described in greater detail hereinafter. When the piece of baggage K passes into the proximity of the printer 10 or a writing and/or reading unit for RFID labels, which is provided separately from the printer, in that way the RFID label 40 can be written to with fresh items of destination information or same can be read from the RFID label. If however the piece of baggage K is not provided with an RFID label 40 or if the existing RFID label 40 there is defective, the printer 10 can dispense a new RFID label 40 which is written with the appropriate destination information by means of the printer 10 and received in the tag 60 after it has been dispensed from the printer 10.

It is to be noted that the RFID label 40 or 40′ is preferably a passive RFID label, that is to say it does not have its own power supply. The writing or reading operation respectively is effected either inductively or by means of radio waves which are transmitted or received respectively by the writing/reading unit.

The printer 10 according to the invention which is shown in FIG. 2 firstly has a housing 12 which accommodates the individual components of the printer, which are described in greater detail hereinafter. As can be seen from FIG. 2 the housing 12 can be of a two-part configuration, namely comprising an upper housing 12a and a lower housing 12b. It will be appreciated that any other division can also be envisaged.

Arranged in the upper housing 12a in the left-hand region is a printing unit 14 for printing at least one label which is printed by the printing unit 14 with at least items of destination information in encoded and/or uncoded form for the article to be transported. The printing unit 14 can operate in accordance with any desired printing method. In the illustrated embodiment it is preferred for the printing unit 14 to operate on the basis of the thermotransfer printing method. Besides the labels the printing unit 14 can also print or prepare other documents.

The labels to be printed or the material to be printed is fed to the printing unit 14 by way of a total of four mutually separated feed shafts 16a through 16d. The feed shafts 16a through 16d are of a conventional structure and are therefore not described in greater detail here. It should just be noted that the feed shafts 16a through 16d are arranged in fan-like configuration in mutually superposed relationship in such a way that their discharge openings which are not identified in greater detail, for the respective material to be fed, are so oriented that that material can follow a common path when it has left the respective feed device 16a through 16d.

Arranged between the feed shafts 16a through 16d and the printing unit 14 is a writing/reading unit 18 for an RFID label. As can be seen from FIG. 2 the orientation of the feed shafts 16a through 16d and the arrangement of the writing/reading unit 18 for the RFID label makes it possible for that label to be arranged both in roll form and also in the form of a block folded in a concertina-like configuration in the lower housing 12b of the printer 10 as all feed paths defined by the feed devices 16a through 16d open in a common conveyor path which passes through the writing/reading unit 18 to the printing unit 14.

In the present embodiment, disposed in the upper housing 12a is a label roll 20 which is supported rotatably in the upper housing 12a by way of a horizontally extending spindle 22. From the label roll 20 a label web 24 can be fed by way of the first feed shaft 16a and the writing/reading unit 18 for the RFID label to the printing unit 14 or the printing head of the printing unit 14 and printed there. After the printing operation the label is severed from the label web 24 by a blade unit 26 provided downstream of the printing unit 14 in the feed direction, and deposited by way of a dispensing opening (not identified in greater detail) in the upper housing 12a on a deposit surface 28 arranged outside the upper printer housing 12a. So that the printed label does not fall off the deposit surface 28 can be oriented to extend inclinedly upwardly.

As can further be seen from FIG. 2 three cassettes 30a through 30c are arranged in the lower housing 12b in mutually superposed relationship in such a way that they accommodate material which is to be printed upon or written to, in a configuration of being folded in a concertina fashion, in the respective cassette 30a through 30c. As has already been indicated hereinbefore the RFID label can be either in roll form or in concertina-folded form.

The individual cassettes 30a through 30c can be pulled out of the lower housing 12b either individually or however jointly and in that way can be re-filled again.

It is also to be noted that the printer 10 also has an operating panel 42 which is provided at the top left edge of the upper housing 12a and which contains the usual operating elements and display devices. Operating elements and display devices can possibly be additionally provided for the writing/reading unit 18 for the RFID label 40, 40′ so that the items of information which are to be written on to the RFID label 40, 40′ can be inputted directly by way of the printer 10 and read out by the printer 10 and displayed.

FIGS. 3A through 3D show partly sectional perspective views of a tag 60 according to the invention. The tag 60 has a casing 62 which substantially forms a rectangular stiff frame. The casing 62 is made from a non-conductive plastic material which protects the RFID label 40 from an abrupt electrostatic discharge which is induced from the exterior. Provided at the one end of the rectangular frame 62 are fixing means 64 which in the present embodiment are formed by a loop portion formed integrally on the frame 62.

It will be appreciated that the fixing means 64 can also be of such a configuration that they can be released from the rectangular frame 62 and locked thereto again so that the tag 60 can be removed from an article K to be transported and attached thereto.

In its interior the frame 62 has three mutually superposed receiving devices 66a through 66c formed by grooves at the three inward sides of the frame 62. The width of each groove of the receiving devices 66a through 66c is so selected that a label 40, 50 can be inserted.

At the end opposite to the fixing means 64 the rectangular frame 62 has an opening 68 through which the labels 40, 50 can be inserted into the receiving devices 66a through 66c, as is shown in FIG. 3D. In order to be able to pull out an individual label 40, 50 the rectangular frame 62 is at least partially interrupted at that end in its center so that one of the labels 40, 50 can be pulled out for example by means of a finger.

The receiving devices 66a through 66c are so arranged that the central one, that is to say the first receiving device 66b, receives an RFID label 40, whereas the outer two receiving devices 66a, 66c, that is to say the second and third receiving devices 66a, 66c, each receive a respective label 50 which has been printed by the printing unit 14 of the printer 10 according to the invention. In this respect the frame 62 is of such a configuration that, at the top side of the tag 60, it forms a viewing window 70 through which the labels 50 which are disposed in the upper and in the lower receiving devices 66a, 66c can be read from the exterior. It will be appreciated that the rectangular frame 62 can also be of such a configuration that viewing is possible only in respect of one of the labels 50 which are disposed in those two receiving devices 66a, 66c.

As can be seen from FIGS. 3A to 3D, inserted in the upper receiving device 66a is a label 50 with destination information in respect of the article K to be transported, which information is reproduced in uncoded form on the label 50. It will be appreciated that it is also possible to provide there a label having items of destination information in encoded form, for example in the form of a bar code.

The mode of operation of the system according to the invention and the method according to the invention will now be described with reference to an example relating to an airline passenger:

The airline passenger who already has a plane ticket firstly goes to a check-in desk. There he presents his ticket and places a piece of baggage K on a weighing apparatus at that desk. It will firstly be assumed that the baggage K is already provided with an RFID label 40 which is received in the tag 60. The writing/reading unit 18 provided in the printer or a reading unit, which is possibly provided separately therefrom, for RFID labels 40, first checks whether the RFID label 40 is properly operational. If that is the case, the data already ascertained by reading in the ticket are transferred to the RFID label 40 by means of radio waves by preferably a writing and/or reading unit for RFID labels, which is provided separately from the printer 10. Simultaneously therewith, or shortly previously or shortly afterwards, a boarding card and a further label 50 are printed out by means of the printer 10, in which case the label 50 also contains items of destination information in encoded form, that is to say in the form of a bar code, and/or in uncoded form, that is to say in plain text. That label 50 is inserted into the second receiving means 66b of the tag 60. Possibly, a further label can also be produced by the printer 10, which contains personal data and so forth of the airline passenger and is inserted into the third receiving device 66c. The piece of baggage K can then be taken by means of a conveyor system to the respective aircraft, in which case the conveying operation is controlled by the data which are contained in the RFID label 40 and which are read out at switching points and so forth and optionally supplemented.

If, in the procedure for functionality testing of the RFID label 40 which is already on the piece of baggage K, it turns out that the label is no longer properly operational, then the printer 10 immediately delivers a new RFID label 40 which has been written with the items of destination information by means of the writing/reading unit 18 for RFID labels 40 in the printer 10. That RFID label 40 is then inserted by an operator into the middle or second receiving device 66a of the tag 60. The operation which has already been described above is then continued.

If no RFID label 40 has yet been attached to the piece of baggage K by means of a tag 60 or by means of another suitable piece of equipment, the printer 10, as in the case of a defective RFID label 40, can dispense a new RFID label 40 which has at least partially been written with the items of destination information for the piece of baggage K, and then attached to the piece of baggage K by means of a suitable tag 60.

Finally it should also be noted that the RFID label 40, 40′ or the label 50 printed by the printing unit 14 of the printer 10 can contain further items of information, besides the destination information for the piece of baggage K.

1. Use of an RFID label (40) as a destination information carrier for an article (K) to be transported, in particular a piece of baggage, wherein the RFID label (40) which can be reversibly attached to the article (K) remains as a re-writable destination information carrier on the article (K) for further transport operations.

2. Use of an RFID label (40) as a destination information carrier for an article (K) to be transported as set forth in claim 1 wherein the RFID label (40′) is additionally provided with a printing area for receiving printed items of destination information in encoded and/or uncoded form.

3. A printer for preparing at least labels as destination information carriers for an article to be transported, in particular a piece of baggage, including:
at least one printing unit (14) for printing a label (50) with at least items of destination information for the article (K) to be transported in encoded and/or uncoded form,
a first feed shaft (16a) for feeding the label (50) to the printing unit (14),
a writing unit (18) for writing an RFID label (40, 40′) with at least items of destination information for the article (K) to be transported, and
a second feed shaft (16b) for feeding the RFID label (40) to be written by the writing unit (18).

4. A printer as set forth in claim 3 characterised in that there is provided a reading unit (18) for an RFID label (40).

5. A printer as set forth in claim 3 or claim 4 characterised in that at least the reading unit (18) for the RFID label (40) is arranged upstream of the printing unit (14) in the feed direction of the labels (40, 40′, 50).

6. A printer as set forth in one of claims 3 through 5 characterised in that besides the first and the second feed shaft (16a, 16b) there is also provided at least one further feed shaft (16c) for delivering a print element to be printed by the printing unit (14).

7. A printer as set forth in claim 6 characterised in that each feed shaft (16a, 16b, 16c, 16d) is connected to a supply unit (20, 30a, 30b, 30c) for a respective kind of a print element (50) to be printed or RFID label (40) to be written to.

8. A printer as set forth in one of claims 3 through 7 characterised in that there is provided a reading unit for smart cards.

9. A printer as set forth in one of claims 3 through 8 characterised in that there is provided a writing unit for smart cards.

10. A tag for an article to be transported, in particular for a piece of baggage, including:
at least one casing (62) for receiving at least one label (40, 50),
fixing means (64) for attaching the casing (62) to the article (K) to be transported, and
at least one first receiving device (66a) provided in the casing (62) for receiving an RFID label (40).

11. A tag as set forth in claim 10 characterised in that there is provided a second receiving device (66b) for a label (50) with printed information in encoded and/or uncoded form.

12. A tag as set forth in claim 11 characterised in that the second receiving device (66b) is arranged over the first receiving device (66a).

13. A tag as set forth in claim 11 or claim 12 characterised in that the second receiving device (66b) has a reading window (70).

14. A tag as set forth in one of claims 10 through 13 characterised in that there is provided a third receiving device (66c) for a further label with printed information in encoded and/or uncoded form.

15. A tag as set forth in claim 14 characterised in that the third receiving device (66c) has a reading window which is accessible from the exterior.

16. A tag as set forth in claim 14 or claim 15 characterised in that the first receiving device (66a) is arranged between the second and the third receiving devices (66b, 66c).

17. A tag as set forth in one of claims 10 through 16 characterised in that the first, second and third receiving devices (66a-66c) are each formed by two respective mutually opposite guide grooves which embrace the labels (40, 50) at the edges thereof in a C-shape.

18. A tag as set forth in one of claims 10 through 17 characterised in that the labels are arranged replaceably in the receiving devices (66a-66c).

19. A tag as set forth in one of claims 10 through 18 characterised in that the fixing means (64) are adapted to be releasable.

20. A tag as set forth in one of claims 10 through 19 characterised in that the RFID label (40) is insulated in relation to an electrostatic discharge.

21. A tag as set forth in one of claims 10 through 20 characterised in that the casing (62) is made from an electrically non-conductive material, preferably plastic material.

22. A tag as set forth in one of claims 10 through 21 characterised in that the casing (62) is stiff.

23. A system for labeling an article to be transported, in particular a piece of baggage, with its destination, including:
a printer (10) as set forth in one of claims 3 through 9,
at least one tag (60) as set forth in one of claims 10 through 22, and
at least one RFID label (40).

24. A system as set forth in claim 23 characterised in that provided separately from the printer (10) is an RFID label writing and/or reading unit which upon recognition of an RFID label (40) detects the freedom from fault thereof.

25. A system as set forth in claim 24 characterised in that the RFID writing and/or reading unit is portable.

26. A system as set forth in one of claims 23 through 25 characterised in that the printer (10) is connected to an input/output unit of a computer.

27. A system as set forth in claim 26 characterised in that the input/output unit includes a unit for reading encoded information stored in a memory.

28. A method of labeling an article to be transported, in particular a piece of baggage, with its destination, including the following steps:
providing the article to be transported with an RFID label,
writing at least the items of destination information into the RFID label, and
providing the article with at least one label on which at least the items of destination information are printed in encoded and/or uncoded form.

29. A method as set forth in claim 28 wherein the RFID label remains on the article after reaching the destination.

30. A method as set forth in claim 28 or claim 29 wherein in the case of an article already provided with an RFID label the RFID label is checked for freedom from fault prior to writing of the RFID label.

31. A method as set forth in one of claims 28 through 30 wherein in the case of a defective RFID label a new RFID label is dispensed by a dispensing device, already provided with the corresponding items of destination information.

32. A method as set forth in one of claims 28 through 31 wherein prior to or after writing of the RFID label at least one label which contains items of destination information in encoded and/or uncoded form is printed and dispensed for the article to be transported.

33. A method as set forth in one of claims 28 through 32 wherein the RFID label and the at least one printed label are received in a tag which can be attached to the article to be transported.
